(19) United States
(12) Patent Application Publication
(10) Pub. No.: US 2005/0175026 A1
(43) Pub. Date: Aug. 11, 2005

(54) Shared-schedule communication network access protocol

(75) Inventor: Deepak V. Ayyagari, Vancouver, WA (US)

Correspondence Address: Robert D. Varitz;ROBERT D. VARITZ, P.C., 2007 S.E. Grant Street, Portland, OR, 97214, US

(73) Assignee: Sharp Laboratories of America, Inc.

(21) Appl. No.: 10/775,723

(22) Filed: Feb. 9, 2004

(51) Int. Cl. H04B 7/212; H04L 12/413

(52) U.S. Cl. 370/443; 370/445

(57) ABSTRACT

A computer-based communication network including a communication medium, and plural, self-timing-controlled, participating communication nodes operatively connected to that medium and operable to gain transmission access to the medium based upon prior transmission-scheduling knowledge, along with future-transmission, deferential, time-slot scheduling. Time-slot scheduling, which is broadcast by each node every time that it communicates over the network medium, is self-performed substantially autonomously by the network nodes, and is based upon an access-control protocol which effectively operates continually in relation to a span of time that brackets the current moment, where that span encompasses a time extent which includes currently knowable, prior, time-slot-scheduling history, along with future time-slot-scheduling intension.

### BACKGROUND AND SUMMARY OF THE INVENTION

The present invention relates to a contention-based, computer implemented network communication access-control system and method which focus attention on access control to a shared network transmission medium in a manner which promotes collision avoidance between nodes competing for communication access. Access control is based upon a style of nodal differential self-scheduling and self-initiated monitoring wherein nodes seeking to transmit data reserve scheduling opportunities for themselves in the deferential light of other nodes' prior-implemented self-scheduling activities. The schedule employed by nodes in accordance with the invention is also referred to herein as a contemporaneous schedule.

The contention-based, medium-access-control “protocol” upon which the present invention rests thus uses a novel collision avoidance approach which, as will become apparent, significantly improves the throughput of network communication, and significantly reduces delays conventionally incurred in transmitting messages over a shared, or common, communication channel.

As will be seen, the present invention, in its structure and its methodology, is based upon having network nodes generate and transmit a “reservation” time schedule (or time slot) of future intended transmissions not only of their own, but also of every other node in the network which has established a prior, and yet unused, transmission time-slot reservation. This deferential, and to some extent self-disciplining, scheduling approach allows nodes wanting to transmit messages of their own to possess knowledge of the times when the communication medium or channel is likely to be busy, and to avoid using, or scheduling to use, those times in attempting to access the channel for transmission purposes.

The various features and advantages which are offered and attained by the structure and methodology of this invention will become more fully apparent as the description which now follows is read in conjunction with the accompanying drawings.

### DESCRIPTION OF THE DRAWINGS

FIG. 1 is simplified block/schematic view of a communication network showing three communication nodes connected for sharing transmission access to a common transmission medium.

FIG. 2 (second plate of drawings) provides, in block and text form, a detailed representation of the operational setting which is defined for nodes in the network of FIG. 1 in accordance with a preferred and best mode embodiment of, and manner of practicing, the present invention.

FIG. 3 is a diagram of a representative Shared Schedule Access Protocol (SSAP) message describing the architecture of each transmission which is engaged in by the nodes shown in the network of FIG. 1 in accordance with practice of this invention.

FIGS. 4, 5, and 6 (first plate of drawings) are stylized block/schematic diagrams illustrating representative communication activities undertaken in accordance with practice and implementation of this invention in a serial time sequence by the three communication nodes shown in the network of FIG. 1 with respect (a) to their reception of information regarding prior-scheduled transmission intensions, (b) to their communications thereof, and (c) to their future scheduling of their own respective future transmission intensions.

### DETAILED DESCRIPTION OF THE INVENTION

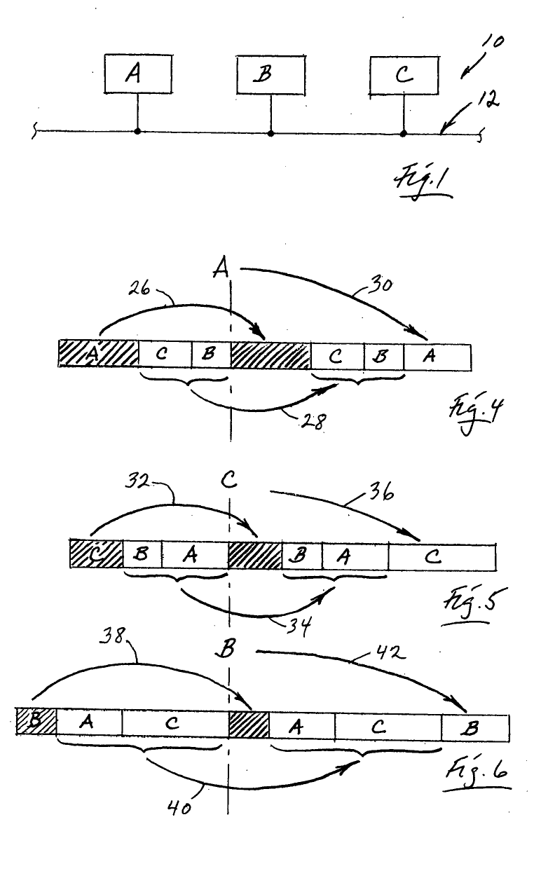

Turning now to the drawings, and referring first of all to FIG. 1, indicated generally and fragmentarily at 10 is a computer-based communication network which, as illustrated, includes three communication nodes A, B, and C each appropriately connected to a shared, or common, transmission medium 12. Under the control of what is referred to herein as a Shared Schedule (communication network) Access Protocol (SSAP), implemented in accordance with structure and methodology proposed by the present invention, these nodes gain access for communication over medium 12 in a collision avoidance manner, and in accordance with certain definitive rules of “behavior” which will now be described in detail. Reference is now made to all of the other drawing figures.

The SSAP protocol defines a timing based collision avoidance mechanism. The timers defined for SSAP are system parameters that each node has to know a priori before using SSAP. This implies that the values of the timers are pre-specified global variables.

In order for nodes to generate schedules, they must either have packets available to transmit, or they must know when their packets will be ready for transmission. For instance, a schedule cannot be generated in advance for data which has yet to be generated by different applications. A node can schedule transmission only after a packet has been generated. However, certain control applications may transmit known control messages periodically or repetitively, and SSAP has been found to be particularly useful for such control applications.

With attention focused initially on FIG. 2, this figure is seen to include six ovate blocks, 14, 16, 18, 20, 22, 24 interconnected operatively by various text-labeled arrows. With reference made especially to these six blocks and to the inter-extending arrows, the SSAP protocol of this invention operates in the following manner.
1. START (block 14): Every node using SSAP resets the expired time on the timers T_SSAP_DURATION and T_SSAP_LISTEN to 0, starts the timers and enters the LISTEN (block 16) state. T_SSAP_DURATION is a timer that designates how long the node plans to use SSAP. T_SSAP_LISTEN is the maximum duration of time the node must spend in the LISTEN (block 16) state.
2. LISTEN (block 16) state: Every node that wishes to transmit, must first listen to the channel for a period of time no less than T_SSAP_LISTEN. This is called the LISTEN state, or phase. During the LISTEN state the node monitors the channel and interprets any SSAP encoded messages that may be received on the channel. The node maintains a schedule of future transmissions that is updated with every SSAP message that is received by the node. The node is not allowed to transmit in the LISTEN (block 16) state. The states of listening and transmitting (or engaging in transmission) herein are referred to as mutually exclusive states. In the practice of this invention, participating nodes abide by the schedule which is set for nodal transmission.

Events and Operations:
(a) If the node has no packet to transmit, and the T_SSAP_LISTEN timer expires while T_SSAP_DURATION is still ongoing, the node restarts T_SSAP_LISTEN and continues in the LISTEN (block 16) state.
(b) If the node has no packet to transmit, and the T_SSAP_DURATION timer expires, the node goes the STOP (block 24) state and exits SSAP.
(c) If the node has a packet to transmit using SSAP, then it can exit the LISTEN (block 16) state in one of two ways:
   (1) If T_SSAP_LISTEN expires, and the node has a packet to transmit, the node immediately moves to the SCHEDULE and MONITOR (block 18) state, and then to the TRANSMIT (block 20) state.
   (2) If an SSAP encoded message is received indicating that another node is already using SSAP, the node may immediately leave the LISTEN (block 16) state and enter the SCHEDULE (block 18) state if it has a packet to transmit. This is optional, and the node may choose to let T_SSAP_LISTEN expire before it moves to the SCHEDULE (block 18) state.
(d) During the LISTEN (block 16) state, the node monitors the channel, and updates the schedule of future transmissions derived from the most recent SSAP message received. The node, it will be remembered, does not transmit in the LISTEN (block 16) state.
3. SCHEDULE and MONITOR (block 18) state: When a node enters the SCHEDULE (block 18) state, it checks its schedule to see when nodes have reserved times for future transmissions. The node also checks to see if it has reserved for itself a transmission opportunity in the future. In this state, the node determines the time for the transmission of the packet it currently holds, and as well, reserves a transmission opportunity in future for its own future packet transmission.
   (a) Scheduling Current Transmission: Upon examining the schedule of future transmissions, if the node finds that a time for transmission has been already been reserved by the node, then the node waits for that time to transmit its current packet. If the schedule does not contain any transmit opportunities reserved for the node (for instance, when the node transmits its very first packet in SSAP), the node can then schedule its transmission in one of two ways:
   1. Chooses the first free time available as per current schedule
   2. Picks at random (per a uniform distribution), a start time within a window of length T_SSAP_DURATION (the window is of length equal to the time remaining on the T_SSAP_DURATION timer).
   (b) Scheduling next transmission time: The node transmitting the SSAP message must schedule only one transmission opportunity for itself in the future. This is in the interest of keeping the message short. The protocol can support scheduling of multiple transmissions in the same message if need be. This time is included in the schedule contained in the SSAP message being transmitted by the node. The next transmit opportunity is scheduled per the following rules:
      (1) The node may choose any time in the future to schedule for itself a transmission that does not conflict with the transmission times of the previously scheduled transmissions, as learned from the most recent SSAP message received by the node.
      (2) Further, a node must not schedule its future transmission during the transmission interval for any previously scheduled future transmission. The transmission interval is the time required to transmit a maximum size SSAP message at the lowest bit rate allowed by the channel.
      (3) Each node chooses a random time from the set of all available transmission times, within a certain window, to schedule its transmission. The next transmission has to be scheduled within the time interval specified by the timer T_SSAP_DURATION. This timer may be reset, or changed, as the network operates in the SSAP mode. This is an option which does not form any part of the present invention.
   (c) Construct SSAP message: The node constructs an SSAP message, encapsulating the packet it wishes to transmit. The SSAP message contains the next time at which the node intends to transmit again, and the scheduled times for the next transmission opportunities for all nodes that have indicated an intention to transmit, prior to the node transmitting its SSAP message. Such an SSAP message can be described as having the following construction:
   List of Previously Scheduled Transmission Times: In order to determine and indicate in its SSAP message when other nodes have scheduled transmissions, the node uses information contained in the most recent SSAP message heard by the node just prior to transmitting the SSAP message. The message should indicate when nodes are expecting to transmit again. Since no absolute time reference is available, the times of the next scheduled transmissions are indicated by the node transmitting the SSAP message at the current time, as the increment from time of transmission; i.e. if T_A represents the time of transmission of the SSAP message by Node A, and T_B and T_C are the next scheduled transmissions by nodes B and C, respectively, then the future transmissions of nodes B and C are indicated as A_B and A_C in the SSAP message from node A, where T_B=T_A+A_B and T_C=T_A+A_C.
   (d) Monitor the Channel: The node must listen to the shared communication channel while it waits for the chosen transmission time. If no SSAP message is received before the chosen start time, the node proceeds immediately with its first transmission of the SSAP message in the TRANSMIT (block 20) state. The time of the first transmission must not conflict with scheduled transmissions as advertised in the SSAP message, if any such messages are received by the node just prior to transmitting its first SSAP message. The node must pick a new start time if there is a conflict.
4. TRANSMIT (block 20) state: The node transmits its SSAP message with the appropriate payload at the scheduled time. The node may reset the time expired on the timer T_SSAP_DURATION to 0, and may re-start the timer as soon as it finishes transmission of the SSAP message. The node may choose not to reset, and rather to restart the duration timer and allow it to run. This choice may be made depending on the applications using SSAP. If all nodes reset and restart their T_SSAP_DURATIONS every time they hear the completion of a successful transmission in IDLE (block 22) state, or in SCHEDULE AND MONITOR (block 18) state, or at the end of each transmission in TRANSMIT (block 20) state, nodes acquire approximate synchronization in time, and this feature might be useful for certain applications. The node moves to the IDLE (block 22) state when it completes transmission.
5. IDLE (block 22) state: During this state the node does not transmit. The node listens to the channel and extracts and updates its schedule of future transmissions from every SSAP message that is received. If the node has no packet to send, it continues in this state until T_SSAP_DURATION expires, following which event it terminates SSAP and enters the STOP (block 24) state. If the node has a packet to transmit, it enters the SCHEDULE and MONITOR (block 18) state from the IDLE (block 22) state.

The format of all messages using the SSAP protocol is clearly defined in FIG. 3 in the drawings. The fields in this message must be present in any message transmitted by a node using SSAP. The size of each field indicated in FIG. 3 is only a recommendation, or illustration, and does not limit the protocol in any way. The maximum size of the SSAP message is set by the parameter MAX_SSAP_SIZE.

With reference now especially to FIG. 3, the SSAP message fields are characterized in the following manners:
1. SSAP Enable: This bit is used to indicate whether the SSAP protocol is being used.
   (a) If the SSAP Enable bit is set to 0, this indicates that SSAP is disabled. In this case, some other access protocol is in use. If SSAP is being used, SSAP Enable bit is set to 1.
   (b) SSAP Enable set to 1 also indicates that all the following fields as indicated in FIG. 3 are valid in the SSAP message.
2. Message Type: This optional field indicates the format and function of the message carried in the PAYLOAD section of the message. For instance, the NODE_DISCOVER_MSG message used in the discovery process, and the CCo_ELECT_MSG messages used in a CCo (Central Coordinator) election process in certain network organization algorithms, are different types of messages both of which use the SSAP protocol.
3. Number of Future Transmissions: This field indicates how many future transmissions have been scheduled and announced. Since each node can only schedule one future transmission, this number also indicates the number of nodes that are participating in sharing the medium using SSAP.
4. Next Scheduled Transmission: This field lists when, in the future, nodes have scheduled and announced transmissions. The field provides the time of transmission in terms of the time differential from the transmission time of the current SSAP message and the scheduled transmission. In the interest of brevity, the identity of the transmitting node is not provided, just the time of its transmission. Optionally, the identity of the transmitting node may also be specified with the time.
5. Payload: This is specific to the type of message (the content) using SSAP.

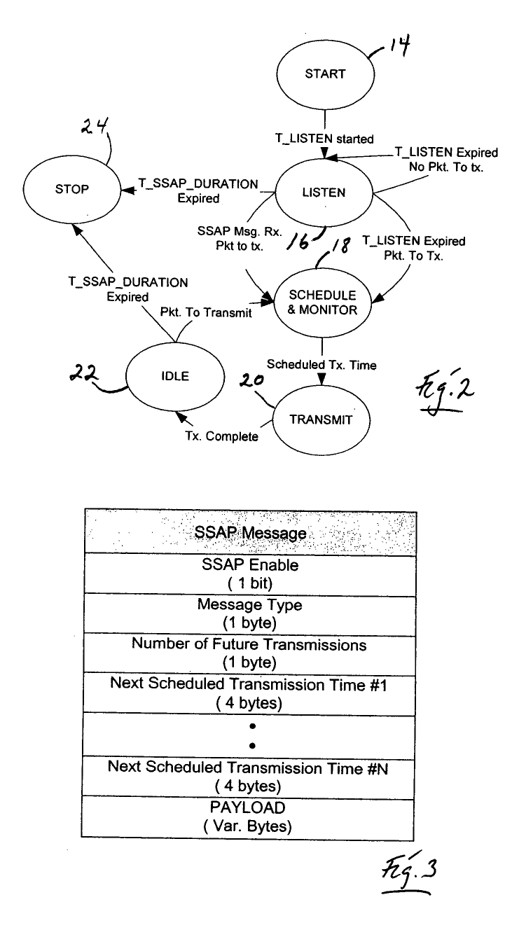

Turning attention now particularly to FIGS. 4, 5 and 6, these three figures illustrate, for nodes A, C and B, respectively, three different spans of past and future times that bracket three specific moments in time which are relevant to the operations of these nodes in accordance with the invention. These three moments in time are represented by somewhat laterally central, vertical dash-dot lines in these three figures. The bracketing past and future spans of time are represented by horizontal “bar graphs” that are divided into segment blocks which are labeled A, B, and C to relate them, respectively, to nodes A, B and C. Segments to the left of the dash-dot lines represent previously scheduled transmission times and functions, and those to the right of the dash-dot lines represent future scheduling. The lateral lengths of the segments represent durations.

Beginning with FIG. 4 which relates specifically to node A, segments A (shaded), B and C which are disposed to the left in this figure of the mentioned vertical dash-dot line, represent previously scheduled time slots for transmissions by nodes A, B and C. The order of such prior scheduling is not critical.

Node A notes these previously scheduled transmission times, and when the “moment in time” pictured in FIG. 4 arrives, node A transmits its packet (arrow 26), transmits the schedules relating to nodes B and C (arrow 28), and schedules and transmits a new future transmission time for itself (arrow 30).

FIG. 5 represents a later point in time which is relevant to node C. When this moment in time arrives, node C transmits its packet (arrow 32), transmits the schedules relating to nodes A and B (arrow 34), and schedules and transmits a new future transmission time for itself (arrow 36). The transmitted schedule for node A is that which was created by node A in the events just described above with regard to FIG. 4.

Similarly, FIG. 6 illustrates a later moment in time which is relevant to node B. Here, node B transmits its packet (arrow 38), transmits the schedules for nodes A and C (arrow 40), and schedules and transmits a new future transmission time for itself (arrow 42). The transmitted schedules for nodes A and C are those which were created by these two nodes, respectively, in FIGS. 4 and 5, respectively.

Thus, the structure and methodology of the present invention, which uniquely enable deferential and disciplined self-scheduling by nodes in a network, has now been described. In a network where there is no master, or controlling, node, the invention offers an effective and very practical approach to self-controlling how participating nodes share access to the relevant transmission medium.

Variations and modifications will certainly be thought of by those skilled in the art, and all such variations and modifications are deemed to be within the scope of the present invention.

1. A computer-based communication network comprising
a communication medium, and
plural communication nodes operatively connected to said medium, and having transmission access thereto solely on the basis of time-slot transmission scheduling which is self-performed substantially autonomously by said nodes.

2. A computer-based communication network comprising
a communication medium, and
plural communication nodes operatively connected to said medium, operable to transmit information over the medium in a collision-avoidance manner based upon a per-node, time-slot scheduling, access-control protocol which effectively operates continually in relation to a span of time that brackets the current moment, with that span encompassing an extent which includes currently knowable, prior, time-slot-scheduling history, along with future time-slot-scheduling intension.

3. The network of claim 2 which is structured whereby nodal transmission of information is accompanied by nodal transmission of all then-current, future time-slot-scheduled nodal transmission intentions.

4. A computer-based communication network comprising
a communication medium, and
plural, self-timing-controlled, participating communication nodes operatively connected to said medium and operable to gain transmission access to the medium based upon prior transmission-scheduling knowledge, along with future transmission deferential scheduling.

5. The network of claim 4 which is structured whereby nodal transmission includes transmission of all then-current future transmission deferential scheduling.

6. A computer-based communication network comprising
a communication medium, and
plural, self-timing-controlled, participating communication nodes operatively connected to said medium, each of said nodes being operable to gain collision-avoidance, transmission-communication access to said medium only on the basis of a precursor, self-established and designated, time-slot schedule for such transmission which is prepared deferentially with controlling reference to any then currently existing and previously established time-slot schedule that has been created by prior-transmitting, participating nodes.

7. A transmission-medium access-control method practiceable by participating communication nodes that are network connected to such a medium, said method, from the point of view of each such node which anticipates the need to connect to the medium and to transmit data, comprising
listening to network communication traffic which contains node-transmitted data packets, each having a time origin of transmission and being associated, in the overall, current network traffic, with a then-contemporaneous report of future-scheduled, time-slot differentiated and time-dimensioned, specific nodal intensions for transmission access to the medium,
in view of that report, deferentially self-scheduling, in a collision-avoidance manner, at least one self-interest time-slot for its own next transmission,
abiding by that self-interest schedule in terms of next seeking transmission communication access to the medium, and
on engaging in transmission in accordance with said schedule-abiding, associating that transmission with a new, then-contemporaneous schedule of all known, future-scheduled, transmission time-slot intentions.

8. The method of claim 7, wherein said listening by a participating node is performed during a listening state which is defined for the node, said engaging in transmission is performed during a transmission state which is defined for the node, and said two states exist in mutually exclusive periods of time.

9. The method of claim 7, wherein each nodal transmission includes an element of content data, and another element which contains the mentioned then-contemporaneous schedule of future time-slot nodal transmission intentions.
